(19) United States
(12) Patent Application Publication
(10) Pub. No.: US 2013/0114775 A1
(43) Pub. Date: May 9, 2013

(54) ECONOMICAL PRODUCTION OF ISOTOPES USING QUANTIZED TARGET IRRADIATION

(71) Applicants: Steven D. HOWE, Idaho Falls, ID (US); Jorge NAVARRO, Idaho Falls, ID (US); Douglas CRAWFORD, Idaho Falls, ID (US); Terry RING, Sandy, UT (US)

(72) Inventors: Steven D. HOWE, Idaho Falls, ID (US); Jorge NAVARRO, Idaho Falls, ID (US); Douglas CRAWFORD, Idaho Falls, ID (US); Terry RING, Sandy, UT (US)

(73) Assignee: UNIVERSITIES SPACE RESEARCH ASSOCIATION, Columbia, MD (US)

(21) Appl. No.: 13/597,974

(22) Filed: Aug. 29, 2012

Related U.S. Application Data
(60) Provisional application No. 61/528,540, filed on Aug. 29, 2011.

(51) Int. Cl. G21G 1/00

(52) U.S. Cl. CPC G21G 1/001
USPC 376/182

(57) ABSTRACT

A process for producing isotopes by continuously flowing a liquid stream, carrying capsules of target nuclei (NP-237) in solution, through a nuclear reactor (a TRIGA style nuclear reactor). Upon removal from the core of the nuclear reactor and after allowing for the decay of Np-238 to Pu-238, the capsules are emptied and the mixture of elements and isotopes are chemically separated using solvent extraction or ion exchange. Isotopes that are capable of further processing into Pu-238 are recycled to the core for further processing

This application claims priority to U.S. Provisional Application Ser. No. 61/528,540, filed Aug. 29, 2011, the disclosure of which is incorporated herein in its entirety.

### BACKGROUND OF THE INVENTION

1. Field of the Invention

This invention relates to production of isotopes. Specifically, this invention relates to a continuous process for producing isotopes.

2. Description of the Background

Every mission launched by NASA to the outer planets has produced unexpected results. The Voyagers I and II, Galileo, and Cassini missions produced images and collected scientific data that revolutionized our understanding of the solar system and the formation of the planetary systems. These missions were made possible by the use of Radioisotopic Power Sources (RPSs) utilizing Plutonium-238 (Pu-238). The conversion of the radioactive decay heat of the Pu-238 to electricity provides a long-lived source of power for instruments. Unfortunately, the supply of Pu-238 is about to run out. Developing a reliable supply of Pu-238 is crucial to almost all future space missions.

Radioisotopic Thermoelectric Generators (RTGs) have been used in the past for all missions past Mars to provide electrical power to the platform. The upcoming Mars Science Laboratory, however, will utilize Multi-Mission RTGs (MMRTGs) which can operate in the vacuum of space or in a planetary atmosphere. Because of the desire for no moving parts, reliability, and long life, these systems rely on thermocouples to convert heat to electricity and are inherently inefficient. Only about 6% of the thermal energy is converted into electricity. Consequently, the specific masses of the RTG and MMRTG are 200 kg/kWe and 357 kg/kWe respectively. Dwight, Carla C., “Assembly and Testing of the Multi-Mission Radioisotope Thermoelectric Generator (MMRTG) at INL”, Proceedings of the Space Nuclear Systems Forum, Huntsville, Ala., 2009. Thus, the power supplies can be a significant fraction of the platform mass.

Recent advances in Stirling engines at the NASA Glenn Research Center indicate that Advanced Stirling Radioisotope Generators (ASRGs) may provide 25% conversion efficiency. Shaltens, R., “Advanced Stirling conversion systems for terrestrial applications”, NASA technical memorandum 88897, 2007. ASRGs will reduce the amount of Plutonium-238 (Pu-238) required for a given power level by a factor of four. However, ASRGs contain moving parts and may suffer from vibration issues along with shorter life spans than MMRTGs. In addition, the specific mass of the ASRG is 141 kg/kWe.

With current NASA mission plans, the last outer planet mission to Europa in 2020 will consume all of the Pu-238 remaining on Earth. After this mission, no spacecraft will travel beyond Jupiter or within the orbit of Mercury. The NASA mission plan circa 2010 is shown in FIG. 1. As seen in the figure, several missions were planned that would consume around 5 kg/yr of Pu-238. The number of missions also depends on whether the ASRG was qualified for launch and utilized in the missions. If not, the number of missions would be reduced due to the larger Pu-238 requirement for MMRTGs.

Current production methods rely on neutron irradiation of large samples of a few kilograms of Neptunium-237 (Np-237) for a period of around one year. The Np-237 will capture a neutron to make Np-238, which decays in 2.117 days to Pu-238. Unfortunately, the Np-238 has a very large fission probability so that around 85% of the Np-238 that is produced is destroyed before it can decay. In addition, after the irradiation, the large sample must be processed for the Pu-238 to be removed and accumulated. The facility needed to handle large quantities of highly radioactive material is large, complex, and costly.

Currently, NASA and DOE have proposed to produce Pu-238 using the Advanced Test Reactor (ATR) and the High Flux Isotope Reactor (HFIR) reactors at the Idaho National Laboratory (INL) and Oak Ridge National laboratory (ORNL) respectively. These reactors produce high fluxes of thermal neutrons and are very appropriate for Pu production. However, the reactors are already fully subscribed with users. To start Pu production, several of these users will need to be cancelled. Recent estimates of actual production of Pu-238 indicate a rate of 1.5 kg/yr. Given that NASA mission plans circa 2010 showed a demand for over 5 kg/yr, more recent mission plans by NASA (circa 2011) reduced the number of missions to those shown in FIG. 2, in order to match the estimated production rate. With the increased pressure on the U.S. Congress to cut spending, the Pu-238 production program may slow or be halted entirely.

Recently, NASA sponsored a National Research Council to convene a committee to review the status of Pu-238 production. Radioisotope Power Systems: An Imperative for Maintaining U.S. Leadership in Space Exploration, National Research Council committee report. ISBN: 0-309-13858-2, 74 pages, (2009). Their final report, “Radioisotope Power Systems: An Imperative for Maintaining U.S. Leadership in Space Exploration” stated:
“Plutonium-238 does not occur in nature. Unlike ²³⁹Pu, it is unsuitable for use in nuclear weapons. Plutonium-238 has been produced in quantity only for the purpose of fueling RPSs. In the past, the United States had an adequate supply of ²³⁸Pu, which was produced in facilities that existed to support the U.S. nuclear weapons program. The problem is that no ²³⁸PU has been produced in the United States since the Department of Energy (DOE) shut down those facilities in the late 1980s. Since then, the U.S. space program has had to rely on the inventory of ²³⁸Pu that existed at that time, supplemented by the purchase of ²³⁸Pu from Russia. However, Russian facilities to produce ²³⁸Pu were also shut down many years ago, and the DOE will soon take delivery of its last shipment of ²³⁸Pu from Russia. The committee does not believe that there is any additional ²³⁸Pu (or any operational ²³⁸Pu production facilities) available anywhere in the world. The total amount of ²³⁸Pu available for NASA is fixed, and essentially all of it is already dedicated to support several pending missions—the Mars Science Laboratory, Discovery 12, the Outer Planets Flagship 1 (OPF 1), and (perhaps) a small number of additional missions with a very small demand for ²³⁸Pu. If the status quo persists, the United States will not be able to provide RPSs for any subsequent missions.”

The committee estimated the deficit of Pu-238 depending upon the production ability of the U.S. government and the possible advent of the ASRG. The result is shown in FIG. 3. Note that the illustration in FIG. 3 assumes production of 5 kg/yr whereas current estimates are for a maximum of ˜1.5 kg/yr.

The current methods in practice for irradiation of sample targets to produce isotopes in general involve large metal targets or stationary liquid samples in various sample containers. These two methods require a radiation worker to handle the post-irradiated sample and expose him or herself to ionizing radiation. The large metal target method creates large amounts of unwanted isotopes, i.e., fission products in the case of actinide and transuranic target materials.

Processing the large metal targets requires a large facility due to large amounts of fission products created (for example in the case of irradiating ²³⁷Np to make ²³⁸Np) and other unwanted isotopes. The reason for the large amounts of fission products and unwanted isotopes is due to the long irradiation times needed create the specified amount of the desired isotope. The irradiated metal target then needs to be shipped to the processing facility. Shipping the irradiated material causes further worker exposure to ionizing radiation. The physical transportation of the irradiated materials also increases risk of lost, stolen, or damaged irradiated materials.

The process proposed by the U.S. government for new Pu production is the known stationary target method discussed above. In essence, a large target of several kilograms of Np-237 is placed in the reactor for up to a year. Pu-238 is produced after neutron capture in the Np-237 via reactions shown below.

Np-237+n→Np-238

Np-238→beta decay 2.7 days half-life→Pu-238

As discussed above, the problem with this process is that the Np-238 has a drastically large probability of fissioning before it decays. Thus, around 80-90% of the Np-238 is destroyed before it can decay. This means that the targets have a large inventory of fission products making them highly radioactive and very hard to handle and process. Consequently, the facility necessary to handle several kilograms of highly radioactive Np is large and expensive.

### SUMMARY OF THE INVENTION

The present invention presents a solution to the problems of the prior art, enabling higher production efficiencies of the Pu-238 by flowing Np in a solution through the core of the reactor and extracting the Pu-238 continuously at lower mass rates. This process produces Np-238 and then removes it from the reactor before substantial fraction can burn up and be lost. It also allows for much smaller processing facility because smaller amounts are processed continuously and the material is not full of fission products. In addition, this process will produce a substantially smaller waste stream of radioactive acid solution.

Initial studies indicate that up to roughly 400 g/cc of Np can be dissolved in an aqueous nitric acid solution. If this material is made to flow through a reactor at a rate that allows roughly a 1 to 40 day residence in the reactor, then up to 0.02 grams of Np-238 per gram of Np-237 will be produced depending upon the magnitude of the thermal flux in the core. According to various embodiments of the invention, the material can be made to flow through a reactor at rates that allow for 1 to 2 days, for 2 to 5 days, for 2 to 10 days, for 5 to 10 days, for 5 to 15 days, for 10 to 20 days, for 10-30 days, for 10 to 40 days, for 15 to 20 days, for 15 to 30 days, for 20 to 30 days, for 20 to 40 days, or for 30 to 40 days, depending on the magnitude of the thermal flux in the core. The system may be configured to maintain the solution to reside outside of the core for 3 to 20 days allowing the Np-238 to decay to Pu-238. According to various embodiments, the system may be configured to maintain the solution to reside outside of the core for 3 to 4 days, for 3 to 5 days, for 3 to 10 days, for 5 to 10 days, for 5 to 15 days, for 5-20 days, or for 10 to 20 days. The solution may then be made to flow through an ion exchange column for removal of the Pu-238 from the solution. The resin is removed on a weekly basis to the processing facility. Thus, up to 0.1 kg per week of Pu-238 is produced in a reactor with sufficient thermal neutron flux.

The flowing target scenario is not possible to implement in the ATR or HFIR without major interruption of service and extensive cost. However, the flowing target can be implemented in a small commercial reactor such as a TRIGA reactor. A 14 MW TRIGA reactor is licensed for operation in the U.S. and is commercially available from the General Atomics Corporation. Coupled with the cheaper processing facility, the entire complex is within the realm of private development. Initial calculations indicate that the 14 MW TRIGA can produce over 5 kg/yr of Pu-238 via this process.

One challenge with a continuously flowing solution is the possibility of a break or leak in the pipe. Such an occurrence would allow Np loaded solution to feed directly into the core of the reactor, affecting reactivity, possibly enhancing corrosion of the fuel, and ultimately causing a reactor shut down and possible radiation exposure. The concern over such possibility may be met by over-design of the piping system and/or a reduced concentration of the Np in the solution. Alternatively, a “pipe in a pipe” configuration would contain a spill if a leak were to occur, but the whole process would need to be shut down to fix a possible leak shorting the production time to make the desired isotope.

To address these issues, the present invention presents a further alternative method according to which encapsulated aqueous solution containing a high concentration of dissolved Np-237 is carried through the reactor in a continuously flowing water carrier stream. The use of discrete capsules makes the separation process safer, cleaner and the sampling process more efficient. The encapsulation (made of one of a variety of known viable polymers) also provides another layer of thermal moderation to take advantage of the high thermal absorption cross section of ²³⁷Np. In addition, if there is a pipe break in the water stream carrier, the capsules are easily retrieved and the reactor is not contaminated by the water stream, which means there is no reactivity change in the nuclear reactor.

Once the irradiation period is completed, the encapsulated target slowly moves through the water shield and allows for decay time of Np-238. Because the target is encapsulated, the isotopic concentration can be identified with various radiation spectrometers before the separation column steps. If the product does not contain the desired isotopic concentration, the capsule may be cycled back through the nuclear reactor. The capsule contents are individually run through an ion exchange column to remove the Pu-238 specifically. This process allows small quantities of Pu-238 to be processed on a weekly basis so that a much smaller, and less costly, facility is needed to accumulate the Pu-238.

A continuously flowing liquid, bearing capsules filled with dissolved target nuclei, enables a constant production stream of the isotope so that small amounts are processed in a much smaller facility. In addition, the concept has the ability to remedy a spill quickly if it should occur because it only requires the removal of one capsule out of the process, instead of shutting down the entire process. There is little risk of spilling and having a large exposure because the continuously flowing encapsulated liquid targets leads to “quantized” production. Furthermore, a variable concentration that is different from the flowing media in the containment pipe can be put into the capsules. Finally, the quantized encapsulation allows localized containment of fission products and isotope products.

According to a preferred embodiment, the invention is a process for producing isotopes by continuously flowing encapsulated liquid target nuclei through a nuclear reactor (for example, a TRIGA style nuclear reactor). This process takes advantage of the benefits of having continuously flowing target nuclei in an encapsulated liquid to allow for quick chemical separation of the isotopes produced inside the capsules and this keeps the liquid sample from potentially leaking out into the nuclear reactor pool. Common containers that are already in use to hold liquids for irradiation experiments include plastic bottles and other plastic polymer containers. The container is preferably configured to flow in a water carrier stream. The water carrier stream is preferably carried in standard tubing configured to allow the movement of the encapsulated liquid-target carrying containers within the water steam. The water in the carrier stream is pumped through the reactor loop to provide the force to move the capsules through this section of the process. The water carrier stream has two other purposes in addition to providing the flow force: 1) if a capsule is broken inside the piping, the water can be easily cleaned via resin columns and 2) if a capsule is broken, the carrier stream keeps the nuclear reactor from being contaminated. Another benefit of the continuous flow process is that the samples do not have to be handled post-irradiation by a radiation worker as a solid sample would; this process alleviates this exposure point compared to a traditional method for isotope production.

According to a continuous encapsulated flow process, the target nuclei can be set to a flow rate that allows for the optimum irradiation time in the neutron field. The optimum time spent in the neutron field is nuclei-specific and process-specific. The flowing target process allows for many possible product/target combinations. In particular, the invention may be used to produce isotopes for medical use, for example Molybdenum 99.

Once the flowing capsule has been through the nuclear reactor for the correct irradiation time frame, the irradiated target capsule with the irradiated product liquid can be opened inside an air lock chamber to extract the capsule. The irradiated liquid can be extracted from the capsule and can be pumped or gravity fed into a collection tank where any/all post irradiation chemical treatments can be performed. The liquid is then fed into the chemical separation process needed to recover the desired isotopes. The extracted container inside the air lock chamber can be pushed with an air blast to be recycled, refilled with more target solution, resealed, and sent back into the nuclear reactor loop. Resealing the opened container can be done by applying a chemical welding agent such as MEK (methyl ethyl ketone) to the opening, a plastic heat-sealing method, or any other suitable resealant method could seal up the open container. Again, no human handling of the irradiated sample need take place since the process is continuously flowing and encased inside the flow process.

The chemical separation may be started immediately as the irradiated sample is already in liquid form ready to be mixed with the required reagents and poured into the isotope separation process, i.e. ion exchange resin columns or any staged liquid/liquid extraction method needed to perform the isotope separation. Since the liquid is encapsulated, it may be quality controlled before the separation process begins. The separation process can be gravity driven allowing for fewer moving parts.

The streams from this process are: product stream, target stream to be recycled, a clean excess solution to dissolve the target isotope, and a waste stream containing unwanted isotopes. The target recycle stream can be fed back into the process by joining up with the target feed stream and fill the open containers to start the process over again. The excess solution stream can also be recycled back to the process to dissolve new target nuclei. The waste stream can be analyzed for other isotopes and stored for future use. Whereas current methods of Pu-238 production produced thousands of gallons of liquid waste per year, the method of the present invention will produce only a few kilograms of resin beads covered with only grams of fission products.

According to separation process, after extraction from the capsules, the irradiated solution is transported to a pre-conditioned ion exchange resin where the Pu and Np are first adsorbed from the nitric acid carrier solution, and sequential stripping solutions are then used first to elute Pu as a product solution, and then to elute Np for recycle. The adsorption and elution steps occur on the same ion exchange tank(s) by the use of control valves that allow for selectable flow of the different solutions into and out of the ion exchange tanks. There is an additional reverse osmosis column which removes water to concentrate the Np solution for recycle. The water removed is reused in the dilution of the nitric acid solution used for stripping in the 3rd ion exchange step. In this way radioactive wastes are minimized. In this process configuration, a Reverse Osmosis unit is used to provide water for stream dilution that is then used for Np stripping and for generating a more concentrated Np solution for recycle.

The present invention also includes an improved process of making sintered pellets for the MMRTGs, i.e. the “back end” of the process. The prior art process uses solid Pu-238 and ball-mills the material to make a distribution of powder. Some of the particles are sub-micron in size. These small particles migrate through seals in glove boxes and are responsible for all of the worker exposures over the past few decades. According to the present invention, the pellet manufacturing process will take the aqueous solution resulting from the production process and produce large diameter spheres of Pu-238. Compaction of the spheres into a standard “pellet” geometry with the correct physical properties will enable less handling by human workers, a reduced facility footprint, reduced cost, and a smaller waste stream.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 shows a graph of missions to outer planets planned by NASA circa 2010.

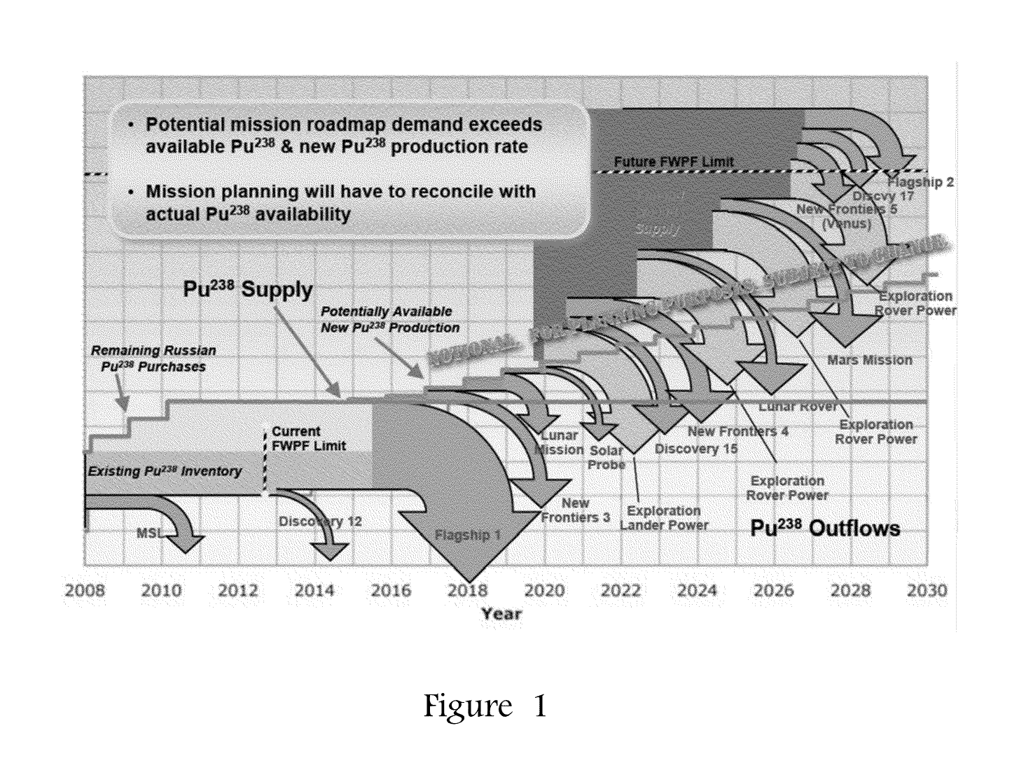

FIG. 2 shows a graph of NASA mission plans assuming a 1.5 kg/yr production rate of Pu-238.

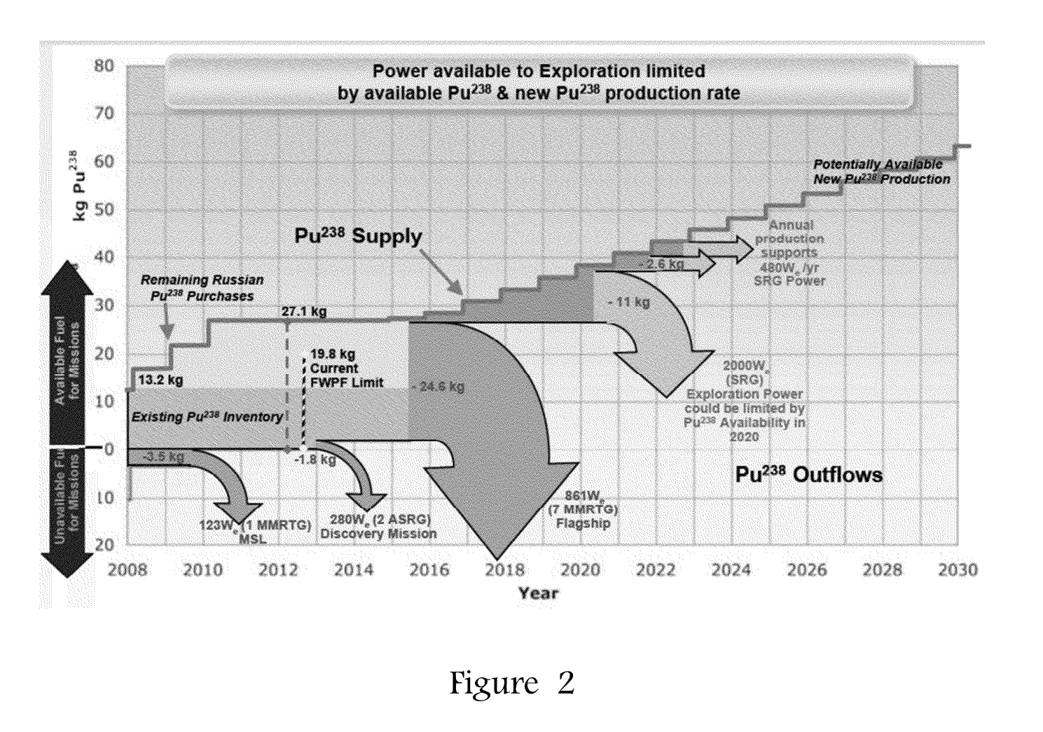

FIG. 3 shows the Pu-238 balance in U.S. stockpile assuming production of 5 kg/yr whereas current estimates are for a maximum of ˜1.5 kg/yr.

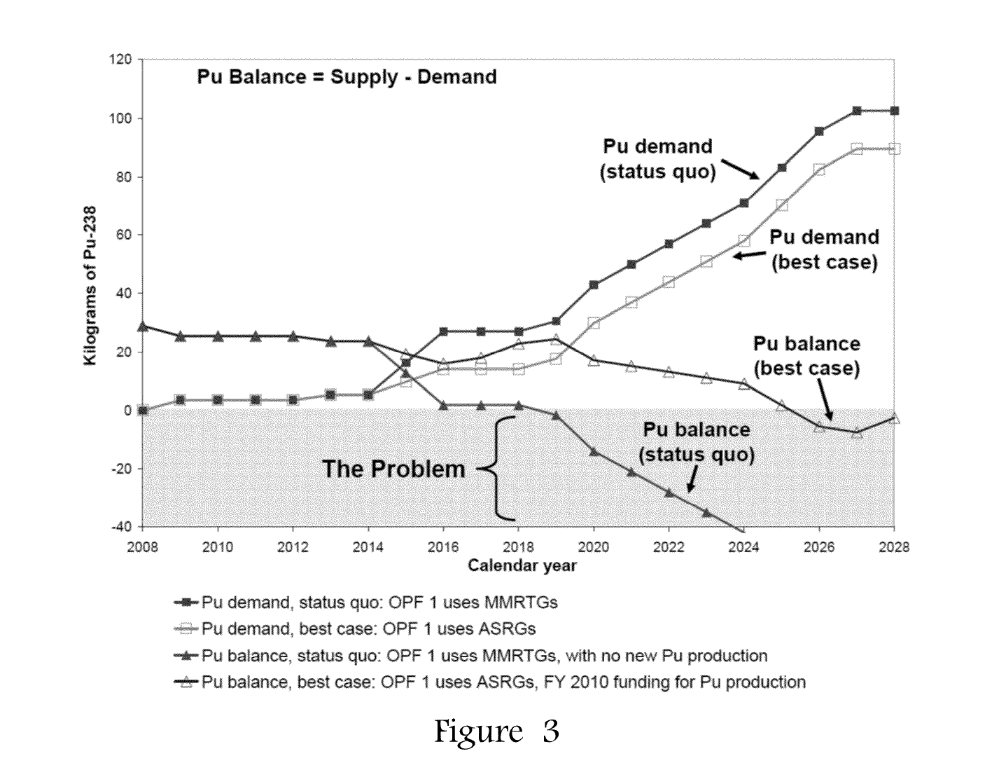

FIG. 4 shows a plot of the energy dependent microscopic cross section for ²³⁷Np absorption (red plot), ²³⁷Np fission (green plot), and ²³⁷Np to ²³⁶Np decay (blue plot).

FIG. 5 shows the spectra of neutrons at three locations in the 1 MW TRIGA reactor at Kansas State University.

FIG. 6 shows the calculated concentrations of various isotopes as a function of irradiation time in a flux of 1×10¹⁴ n/cm²sec⁻¹

FIG. 7 shows cross sections of a hexagonal and a rectangular core reactor.

FIG. 8 shows a plot of mass of Np-237 versus flux level in the core to produce 1.5 kg of Pu-238/yr.

FIG. 9 shows a schematic of the Pu-238 flow process envisioned using Ion exchange columns.

FIG. 10 shows a schematic view of a TRIGA reactor modified to include the continuous flow feedstream tubing/coil and isotope separation and capsule injection stations of the invention.

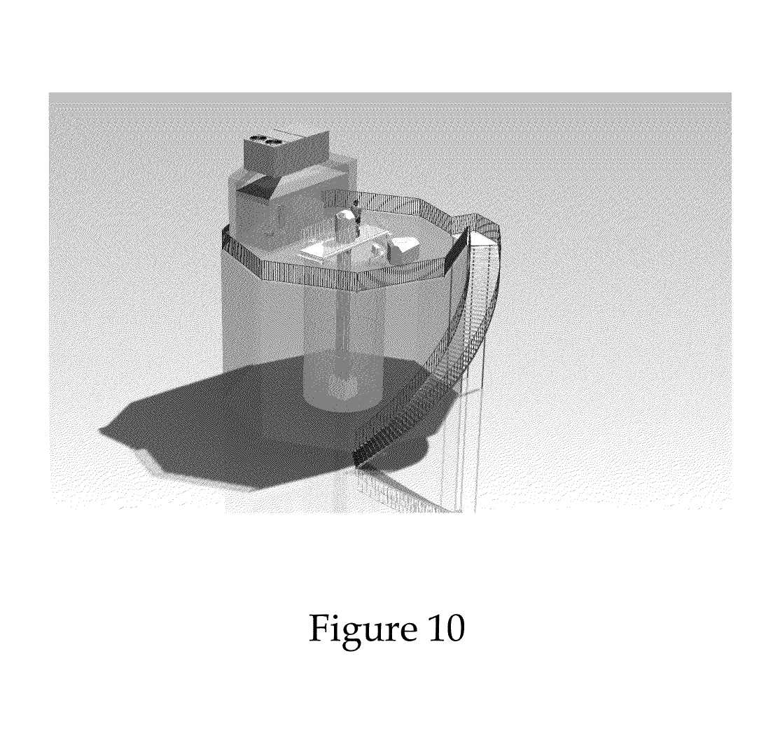

FIG. 11 shows a closer view of the continuous flow feedstream tubing and coil of the invention.

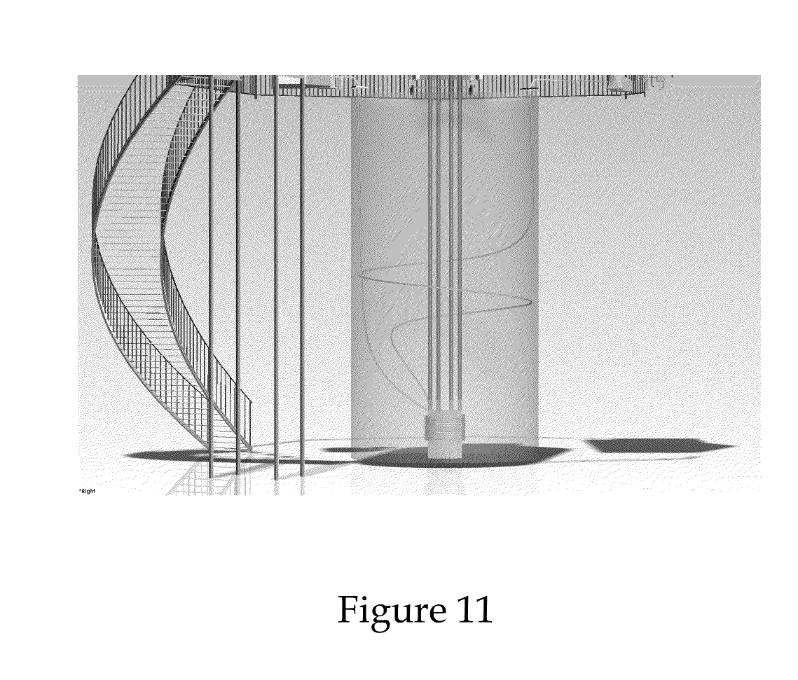

FIG. 12 shows an even closer view of the continuous flow feedstream coil of the invention surrounding the reactor core.

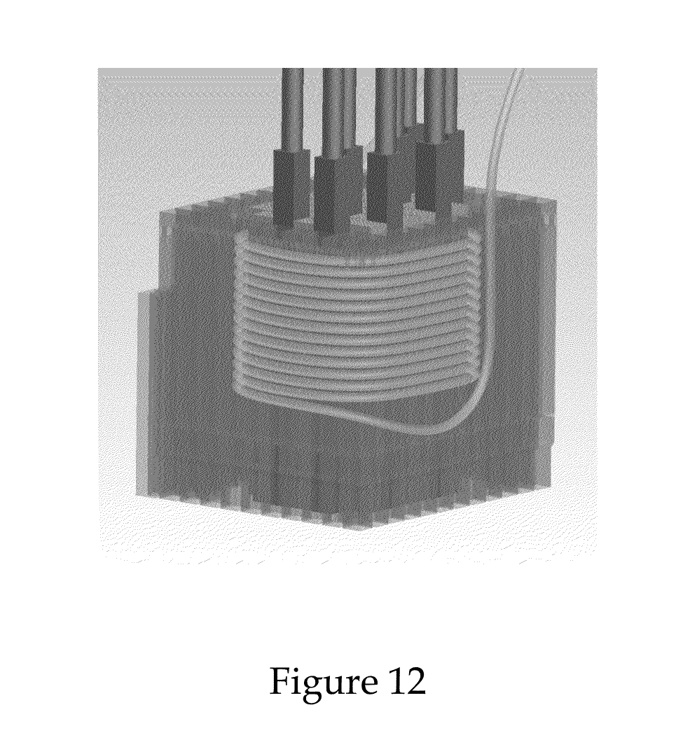

### DETAILED DESCRIPTION OF THE INVENTION

The invention summarized above may be better understood by referring to the following description, which should be read in conjunction with the accompanying drawings. This description of an embodiment, set out below to enable one to practice an implementation of the invention, is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

In particular, while the invention is described hereinbelow with reference to the irradiation of ²³⁷NP to make ²³⁸Pu, this invention may be readily adapted for the irradiation of any number of nuclei to create various isotopes.

According to the invention, a continuously flowing stream containing encapsulated Np solution in discrete capsules is fed through a pipe surrounding a compact, thermal reactor. This allows the concentration of Np to be increased, the risk from a pipe break of a reactor excursion to be decreased, the quality control of the production to be easier, and the processing system and facility to be smaller and cheaper. The concept of quantized encapsulation enables the idea of continuous production to be realized in a safe, robust manner.

A continuous flow process to produce ²³⁸Pu requires two key process components within the nuclear reactor: the first is a thermal neutron flux to take advantage of the very high thermal absorption cross section (σ_{absorption}) in the nuclear reaction:

$${}_{93}^{237} N p + {}_{1}^{0} n {\to }_{{σ}_{absorption} = 150 barns} {}_{93}^{238} N p {\to }_{\begin{matrix}β - decay \\ 2 , 117 days\end{matrix}} {}_{94}^{238} Pu$$

compared to competing fast neutron nuclear reactions:

$${}_{93}^{237} N p + {}_{0}^{1} n {\to }_{{σ}_{f} = 0.02 barns} Fission poducts + {}_{0}^{2} n$$

$${}_{93}^{237} N p + {}_{0}^{1} n {\to }_{{σ}_{n , 2 n} = 0 , 2 barns infest region} {}_{93}^{236} N p + {}_{0}^{2} n$$

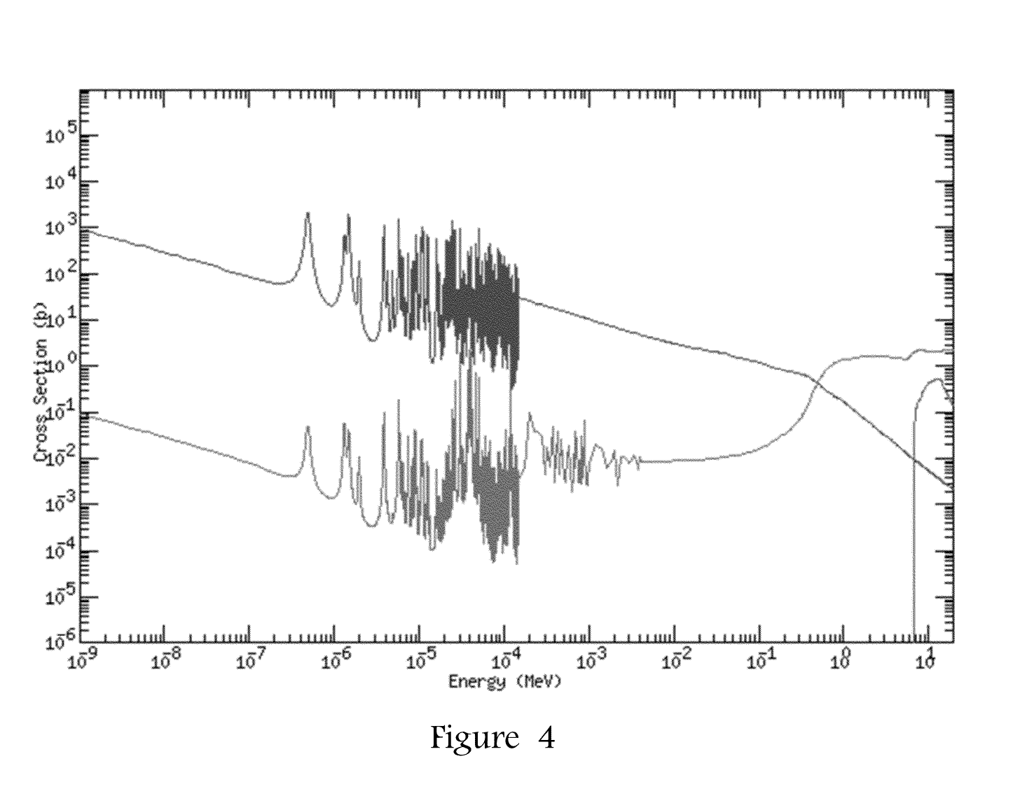

FIG. 4 shows the difference in the three cross sections with the plot in red being the absorption cross section for ²³⁷Np, the green plot is the fission cross section, and the blue plot is the n,2n nuclear reaction.

The second key process component is the balance of the residence time that ²³⁷Np is exposed to thermal neutrons to become ²³⁸Np, followed by the removal of ²³⁸Np/²³⁷Np flow mixture to minimize the loss of ²³⁸Np, shown by the nuclear reaction:

$${}_{93}^{238} N p + {}_{0}^{1} n {\to }_{{σ}_{absorption} = 2100 barns} {}_{93}^{239} N p {\to }_{\begin{matrix}β - decay \\ 2 , 355 days\end{matrix}} {}_{94}^{239} Pu$$

A thermal flux can be maintained in a reactor within a heavy water blanket region. The neutron flux created by the nuclear reactor travels through the heavy water blanket or region, and, due to the properties of deuterium, the change in the lethargy

$$( Δ lethargy \approx \frac{2}{A + \frac{2}{3}} )$$

of the neutrons increases and so the neutrons slow down to thermal energies as a result of collisions with a heavy water molecule. Maintaining a flux below this energy, 0.5 eV or 5×10⁻⁷ MeV, will keep the advantage of the much higher absorption cross section. The thermal neutron flux is reactor dependent and may be calculated with an MCNP model of the reactor used for the experiment, based on the power and geometry of the reactor.

The primary innovation of this invention is the continuous flow feedstream and the use of capsules to “quantize” the feedstream into small units to be treated individually. The capsules allow a solution with a high concentration of Np-237 to be irradiated without the risk of the Np crystallizing or plating out along the flow channel. According to a preferred embodiment, the capsules may contain a concentration of 0.25% wgt (3 Molar) NP-237 nitrate solution. Use of the capsules also allows small quantities of irradiated material to be processed at a time, which reduces the processing facility's size even more. Finally, the use of capsules mitigates the risk of having the pipe break and spill the target solution into the reactor or facility.

Several materials are possible for the capsule if they can resist embrittlement due to the neutron fluence. Glass, aluminum, titanium, ceramics and plastics are possible. The materials must have only short-lived radioisotopes induced by the neutrons and become embrittled by the neutrons. In the case where the encapsulated solution is acidic, polymer materials are preferable. Styrene, nitrile butadiene runner, and ethyl-vinyl-acetate rubber may be used as the capsule materials where the encapsulated solution is acidic.

The capsules may be of any size, but optimization of the production of the isotope indicates a preferred diameter of 1 to 3 mean free paths (MFP) for thermal neutrons. The MFP depends upon the concentration of the target element in the capsule. For Np-237 dissolved in nitric acid to a concentration of 432 mg/cm3, the preferred capsule diameter will range from 3 to 5 cm. The tube carrying the capsules can be made from any material. However, it is important to keep long-lived radioactivity induced by the neutrons to a minimum. Accordingly, preferred materials include the use of plastic pipe, glass, titanium, or aluminum as the tube material. Aluminum may be a more preferred choice due to cost, strength, and availability. The tube diameter is preferably 1 to 2 cm greater than the capsule diameter

According to a preferred embodiment, the reactor is characterized by a high thermal flux of neutrons and a design that can already accommodate the flow channel or be easily re-engineered to accommodate the flow channel. The residence time in the core, the decay time out of the core, and the processing of the irradiated solution may then be determined. According to a more preferred embodiment, the flow channel may be designed to form a loop and configured to provide nearly a plug flow design by adding bubbles into the flow loop after each capsule. The size of the bubble may be configured to be the size of a cylinder inside the tube feeding the flow loop (a coil of tubing) with a length twice the diameter of the tube.

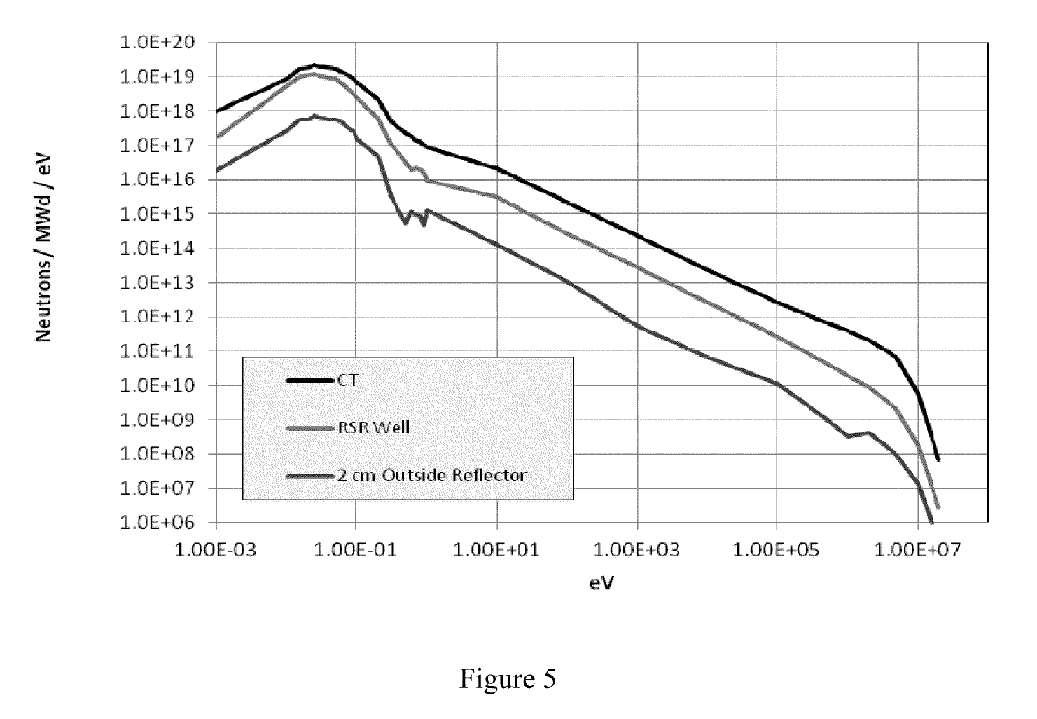

The flux spectra for three different locations in a TRIGA core are shown in FIG. 5. The spectra show that the neutron fluence outside the core is more thermal, i.e. the ratio of low energy to high energy neutrons is bigger than at the other two locations. However, the magnitude of the flux is lower by two orders of magnitude. Placing the target material in the CT location will breed more Pu-238 by also more Pu-236. Based on these data, the optimum position in the TRIGA core appears to be at the RSR location. The location in other reactors should be selected to have a similar neutron flux level and neutron spectrum as the RSR location in a TRIGA reactor.

A coupled set of equations determines the residence time of the ²³⁷Np target in the core. These also describe the removal of flowing target in the thermal neutron environment, i.e. the length of the flow tube to minimize the time ²³⁸Np spends in the thermal neutron field. Equations 1 and 2 (the first set of equations) provide insight into the time window needed for the ²³⁷Np target to sit inside the thermal neutron field to transmute to ²³⁸Np. Equations 1 and 2 will also provide the limits on the residence time, τ, defined as the volume divided by the volumetric flow rate,

$$\frac{v}{v} = τ ,$$

that the target, ²³⁷Np, will need to be irradiated.

$$\begin{matrix}\frac{d {N}_{{}_{93}^{237} N p}}{d t} = - {σ}_{absoprtion {}_{93}^{237} N p} * {N}_{{}_{93}^{237} N p} * {φ}_{thermal} - {σ}_{fission {}_{93}^{237} N p} * {N}_{{}_{93}^{237} N p} * {φ}_{thermal} & ( 1 ) \\ \frac{d {N}_{{}_{93}^{238} N p}}{d t} = {σ}_{absoprtion {}_{93}^{237} N p} * {N}_{{}_{93}^{237} N p} * {φ}_{thermal} - {σ}_{absorption {}_{93}^{238} N p} * {N}_{{}_{93}^{238} N p} * {φ}_{thermal} - λ {N}_{{}_{93}^{238} N p} & ( 2 )\end{matrix}$$

The volumetric flow rate may be parameterized from the information Equations 1 and 2 to provide the optimum volume and volumetric flow rate. The volumetric flow has a constant tube cross section so the optimum flow length for the system, L can be found. The length of the tube may be optimized with Equations 3 and 4; where dV=πr²dL, r is the radius of the tube and

$$\dot{V} = \frac{F}{N} ( R [ = ] \frac{atoms}{time} , N [ = ] \frac{atoms}{{cm}^{3}} )$$

is the volumetric flow rate of the feed into the neutron field.

$$\begin{matrix}\dot{V} \frac{d {F}_{{}_{93}^{237} N p}}{π {r}^{2} d L} = - {σ}_{absoprtion {}_{93}^{237} N p} * N {}_{{}_{93}^{237} N p} * {φ}_{thermal} - {σ}_{fission {}_{93}^{237} N p} * {N}_{{}_{93}^{237} N p} * {φ}_{thermal} & ( 3 ) \\ \dot{V} \frac{d {F}_{{}_{93}^{238} N p}}{π {r}^{2} d L} = {σ}_{absoprtion {}_{93}^{237} N p} * N {}_{{}_{93}^{237} N p} * {φ}_{thermal} - {σ}_{absorption {}_{93}^{238} N p} * {N}_{{}_{93}^{238} N p} * {φ}_{thermal} - λ {N}_{{}_{93}^{238} N p} & ( 4 )\end{matrix}$$

These equations allow the flow characteristics to be determined based on desired concentration of the Np and buildup of the Pu. The aqueous solution requires short neutron exposure times, as little as one to two days, preferably from five to forty days, to limit the production of higher isotopes of Pu. For example, past exposures at the Savanna River National Laboratory (SRNL) showed that for short durations with solid Np-237 oxide in its nuclear reactor core, the target converted to Np-238 at an efficiency of 13-15%. The process, which set 4 to 6 days to allow beta decay from Np-238 to Pu-238, showed an isotope suite consisting of 81% Pu-238, 15% Pu-239 and 2.9% Pu-240 with the balance being residual Np-237 and Np-236 (t_{1/2}=22 hrs.; decays to Pu-236 and then to U-236).

The present continuous flow method is expected to produce a similar Pu isotopic mix to that at Savanna River for similar short neutron exposures. The presence of Pu-239 and Pu-240 in the SRNL product indicates that Pu-238 has further reacted with neutrons in the core thus reducing the Pu-238 yield. Thus, residence time will be optimized for “sister” isotope content as well as Pu-238 production.

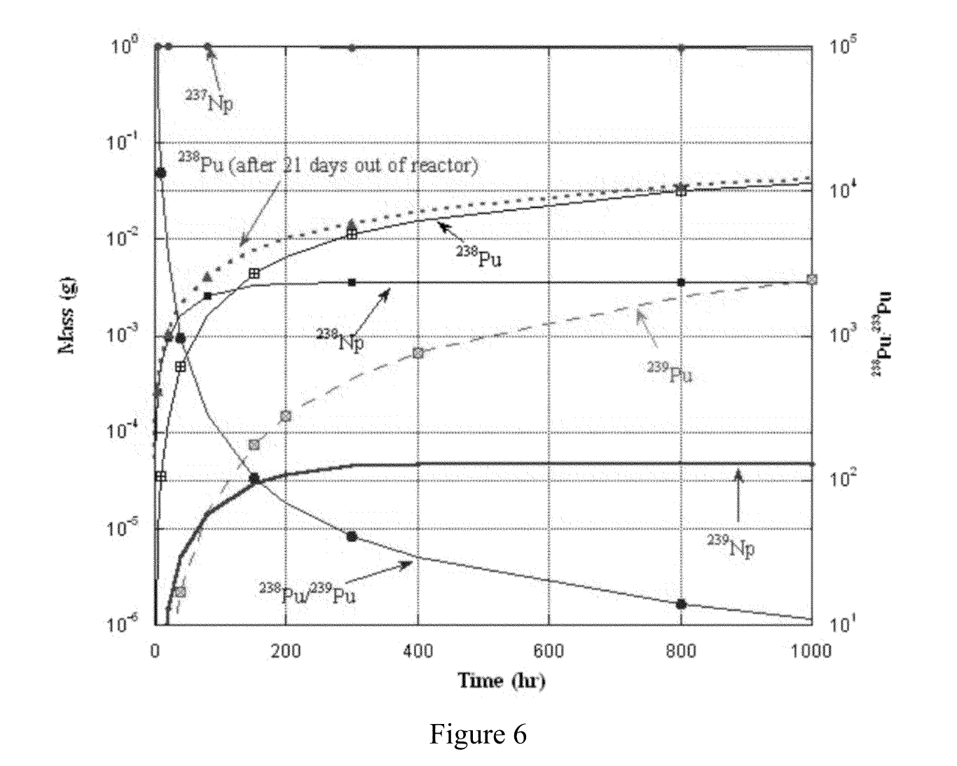

The results showing the time dependence of the various isotopes are shown in FIG. 6. A key observation from the figure is that the Np-238 reaches an equilibrium level very quickly. In other words, by irradiating the samples longer than a few hundred hours simply burns up the NP238 and increases the fission product concentration. This indicates that the irradiation times will be much shorter than the six months currently employed by the DOE program. Given the neutron spectra measured in an existing TRIGA reactor and the known reaction cross sections, the amount of Pu-238 produced as a function of irradiation time per kg of Np-237 feedstock can be calculated. The maximum amount of Np-237 that can be placed in the vicinity of the reactor core without shutting down the reactor (by absorbing too many neutrons) can likewise be determined.

Indeed, calculations showed that placing several kilograms of Np-237 within a TRIGA core actually shut the reactor down, i.e. made the core sub-critical. One of the first tasks was to reassess this conclusion using the geometry of the continuously flowing feedline around the outside of the core. Calculations using MCNP and Scale validated the idea that several kilograms of Np in solution can be placed around the core with negligible impact on the reactivity. These calculations allow for design of the feedline, as well as determination of the mass and velocity of the capsules traveling around the core, the heating rate in the capsules, and the amount of fission products produced.

Preliminary studies of general TRIGA type reactors were modeled to show proof of concept and that 238 Pu production can be achieved. However, this invention is not limited to the use of TRIGA reactors, and may be practiced with any reactor that meets the neutron flux levels and the neutron spectrum required, both of which are met at the RSR (between the core and the reflector) location in a TRIGA.

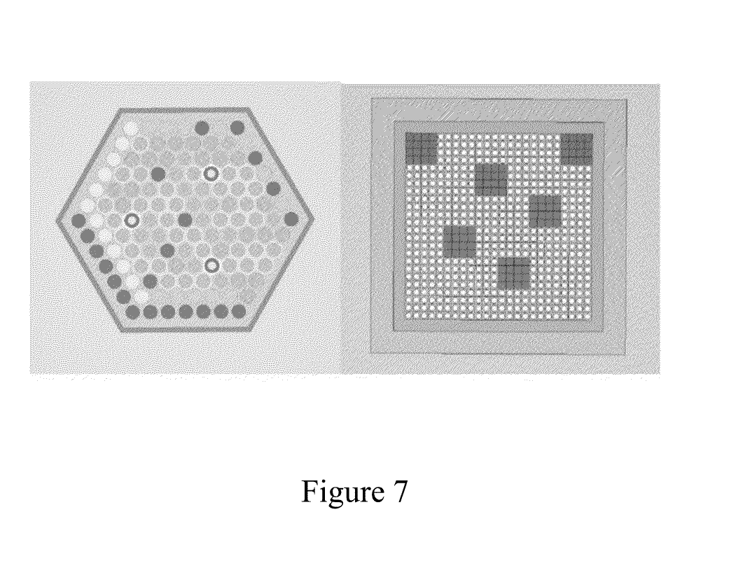

Models of two different TRIGA type reactors were modeled in SCALE6.1 and computed with the TRITON sequence. The TRITON sequence was chosen to ensure the reactor stays critical, provide the necessary flux, and perform the activation analysis. The first model is a hexagonal core pattern with cylindrical fuel, see FIG. 7. The fuel is UZrH1.6, enriched to 20% 235U. This reactor has flux spectra similar to the KSU reactor. The second model is a higher flux, rectangular core, with the same fuel composition.

The reactor studies were geared towards finding the necessary magnitude neutron flux required for the production of Pu238. These core configurations were based on existing operational reactors, some modifications were made for modeling purposes and to achieve the desired conditions.

From the reactor studies, it was determined that placing the liquid target around the core provided the best scenario for activation while maintaining criticality of the reactor. The magnitude of the flux for the hexagonal reactor was too small for production purposes. A nuclear reactor that produced a higher flux around the core was needed to meet production purposes therefore the rectangular core was modeled and met these needs. The production of plutonium is dependent on three parameters: residence time of the Np in the reactor, the neutron flux profile irradiating the targets and the amount of Np flowing through the reactor. The next step was to determine a neutron source flux profile necessary to produce 1.5 kg of Pu-238 per year.

A point design for a Pu-238 production system was completed. The design used as a default reactor design a 5 MW TRIGA. Several vendors have reactors available in this power class. The TRIGA reactor was used for this analysis because it is a well known design and is a good example of the class. In addition, we had measured neutron spectra available for the TRIGA system. However, as discussed above, the design may be readily repeated for any other reactor any reactor that meets the required neutron flux levels and the neutron spectrum.

The analysis allows for variable capsule sizes, variable reactor power and neutron flux levels, and determines the mass of Np-237 required to meet the 1.5 kgs/yr production level. The analysis also determines the processing speed of the capsules as well as the length of the feedline throughout the reactor. The results are summarized in Table 1.

TABLE 1
Point design of the Pu-238 Production System

| Annual Production | 1.5 | kg/yr |
|---|---|---|
| Capsule diameter | 3.0 | cm |
| Capsule length | 7.0 | cm |
| Neptunium concentration | 0.432 | gm/cm3 |
| Feedline diameter | 5.0 | cm |
| Reactor height | 38.0 | cm |
| Reactor diameter | 65.0 | (cm) |
| Irradiation time | 10 | days |
| Decay time | 12 | days |
| Processing time per capsule | 3681 | seconds |
| Capsule velocity | 0.068 | m/hr |
| Number coils core | 7.6 | |
| Number coils decay line | 1.5 | |
| Length feedline core | 15.5 | meters |
| Length decay line | 18.6 | meters |
| Mass Np around core | 4.74 | kg |
| Mass Np in decay line | 5.69 | kg |

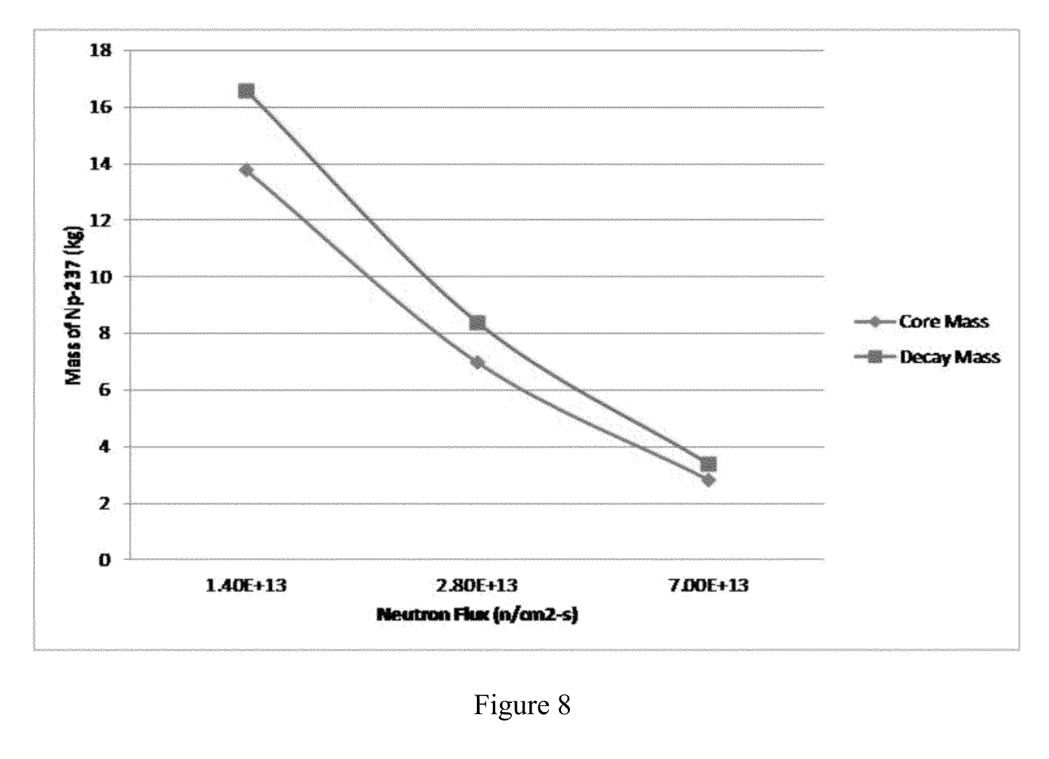

The results show that for roughly 10 kgs of Np-237 in the entire line, we can produce the required 1.5 kg/yr of Pu-238. This value varies with reactor power. The dependence of the Np mass versus flux level in the core is shown in FIG. 8. The figure indicates that higher flux, i.e. a higher power reactor or a modified reactor design, is beneficial.

Qualitatively, the continuous feed method does not require the facility space to decay the irradiated product because the feedline is designed to allow the decay within the water tank of the reactor, i.e. the velocity of the capsules matches the required irradiation time in the core as well as the decay time through the tank. Because the system treats one capsule at a time, the separation lines may be very modest. The entire separation system may be configured to sit on the top of the reactor or immediately nearby so that a separate facility is not required.

Upon removal from the core of the nuclear reactor and after allowing for the decay of Np-238 to Pu-238, the mixture of elements and isotopes may be chemically separated into those that can be recycled to the core for further processing and those that are not to be recycled because they cannot yield more Pu-238. With this process, the Np-237 and Np-236 will be chemically separated from the Pu with various isotopes by using variants of the PUREX process that uses solvent extraction or an ion exchange process, which uses ion exchange columns.

The PUREX process uses tri-n-butyl phosphate (TBP) in dodecane to extract actinides from other metals using solvent extraction. This process may be manipulated according to known methods by altering pH and the valence state of the actinides. The strength of extraction into TBP/Docecane solution from nitrate solution is: U(VI)>Np(VI), Pu(IV)>Np(IV), Pu(VI)>>Np(V), Pu(III). Thus, V(VI) and Np(IV) can be readily separated from the very poorly extracted Pu(III), and U(VI) can be separated from Np(V). Aluminum and other fission products are not extractable with TBP. Once extracted, the actinides can be stripped from the organic solvent by contacting with dilute nitric acid solution.

The ion exchange process is based upon the fact that Np(IV) and Pu(IV) form anionic nitrate complexes of the type Np(NO₃)₆⁻² that are strongly absorbed from concentrated nitrate solution by strong-base anion exchange resins such as Dowex 1-X4. Other oxidation states of Np and Pu are very weakly absorbed, as are most fission products and common metallic cat-ions. Thus, Np(IV) and Pu(IV) can be effectively separated from U and fission products by anion exchange and Np(IV) can be separated from Pu(III). Once the actinides are extracted, they can be stripped from the anionic exchange columns using dilute nitric acid solution.

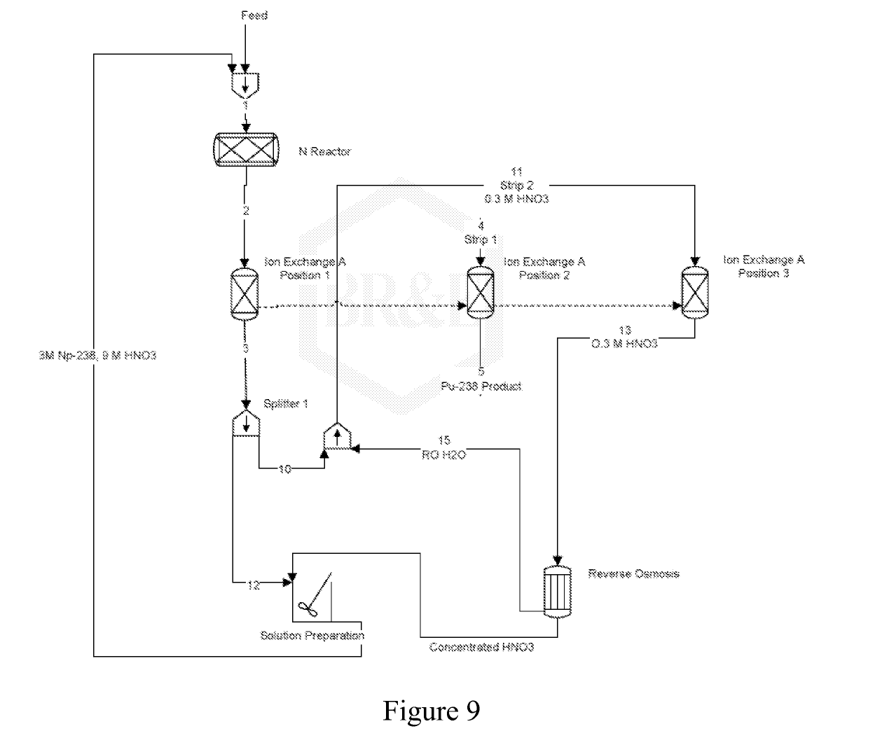

A detailed description of a process to separate Pu-238 from Np-237 is discussed by Groh, et al., Groh, H. J., Poe, W. L. and Porter, J. A., “Development and Performance of Processes and Equipment to Recover NP-237 and Pu-238,” WSRC-MS-2000-00061, p. 165-178. A schematic of the overall proposed process developed is shown in FIG. 9. In a first step, the nitric acid solution is introduced to the ion exchange tanks containing conditioned resin, and Np(IV) and Pu(IV) are adsorbed onto the resin and the nitric acid solution is passed through the tank and collected for recycling and or for stripping of the Np from the resin at a later step. The flow of nitric acid solution into the tank is then cut off (or switched to a parallel resin tank whose process steps are timed to allow shifting of the process flow between ion exchange tanks), and a first eluting solution is introduced to the resin bed to strip Pu(III), leaving Np(IV) bound to the resin, allowing PU-236 to be collected for isotope purification and subsequent oxidation to PuO₂. The first eluting solution is then cut off (or switched to a parallel ion exchange tank), and a second eluting solution is introduced to the resin bed to elute the Np for eventual recycling to the core of the nuclear reactor. Recycling Np-237 to the nuclear reactor for multiple passes effectively converts an additional 13-15% each time increasing the overall yield with each pass through the nuclear reactor. Given that the separation process is a continuous process, the separation time is short, allowing more Np-237 to be converted to Pu-238 allowing less Np-236 to be produced.

The chemical separation may be performed by ion exchange using an anionic resin, e.g. Dowex resin. The common procedure consists of the adjustment of neptunium ion at Np(IV) and the adsorption of Np(IV) nitrate complex, i.e. Np(NO₃)₆², on the anion-exchange resin from 7 to 8 M HNO₃ solution. The anionic nitrate complexes of Pu(IV) and Th(IV) are also adsorbed on the resin at the same time. Pu(IV) is eluted as Pu(III) with a mixture of 6 M HNO₃+0.05 M Fe(II) sulfamate+0.05 M hydrazine. Np(IV) is then recovered by elution with 0.3 M HNO₃. Maiti et al. developed a method for the sequential separation of actinides by anion ion exchange. Maiti, T. C., Kaye, J. H., and Kozelisky, A. E. (1992) J. Radioanal. Nucl. Chem., 161, 533-40. Np(IV) and Pu(IV) in 9 M HCl-0.05 M HNO₃ solution are adsorbed on the anion ion exchange resin. Pu(IV) and Np(IV) are eluted successively using 9 M HCl and 0.05 M NH₄I and 4 M HCl and 0.1M HF, respectively. There is a group of ion exchange resins referred to as chelating resins, e.g. TEVA, TBP-loaded Amberlite XAD-4 resin and Diphonix, that are useful for this separation. See, e.g., Zenko Yoshida, Stephen G. Johnson, Takaumi Kimura, and John R. Krsul, Neptunium, Chapter 6 in

http://radchem.nevada.edu/classes/rdch710/files/neptunium.pdf

The separation process consists of a modified process using key attributes of the above referenced process; see FIG. 9. The separation process according to the invention includes the following steps: 1) the Dowex anion ion exchange resin must first be conditioned with concentrated Nitric acid, 2) the ion exchange resin is then used to treat the mixed nitrate solution where Np(IV) and Pu(IV) are adsorbed onto the resin, extracting them from the 7-8 Molar (M) nitric acid (HNO3) solution (FIG. 9, Ion Exchange A, Position 1); and 3) the ion exchange resin with actinides loaded is then treated to remove Pu(IV) which is eluted as Pu(III) using 2 bed volumes of stripping solution consisting of a mixture of 6 M HNO3, 0.05 M Fe(II) sulfamate and 0.05 M hydrazine (FIG. 9, at Ion Exchange A, Position 2). 4) If thorium is present, Th(IV) is eluted with other actinides with 2 bed volumes of 8 M HCl (this stripping step is not shown in FIG. 9 as it only needs to be done on the solution every 100 passes through the nuclear reactor) and 5) Np(IV) is then recovered by elution with 2 bed volumes of 0.3 M HNO3 (FIG. 9, Ion Exchange A, Position 3). After water removal by Reverse Osmosis (RO) to concentrate the nitric acid stream, the resulting Np(IV) nitrate solution is mixed with nitric acid resulting from Position 1 in a recycle solution preparation step shown in FIG. 9 at “Solution Preparation,” for recycle to the nuclear reactor to facilitate the production of more Pu-238. The water produced during the Reverse Osmosis step is used to dilutes a portion of the nitric acid solution passing through the resin during the first extraction. At the end of all ion exchange operations the ion exchange columns are allowed to drain and air dry so that waste solutions are minimized.

“Back End” Processing

The sol-gel microsphere production apparatus suitable for work with radioactive materials has been developed which uses the internal gelation method to fabricate spheres with tunable diameters less than a millimeter without dust generation. Work with plutonium surrogates has indicated that the internal gelation sol-gel fabrication technique will offer substantial benefits over current precipitation and powder processing methods for Pu-238 sources. Current methods involve an oxalate precipitation of plutonium that yields a powder morphology requiring ball milling, which results in respirable fines. A major advantage of the sol-gel method is that no powders are produced. Plutonium nitrate obtained directly from separation of neptunium following reactor production is used as the feed solution for the sol-gel process. Plutonium remains in solution until it is formed into microspheres of the prescribed size. These gelled microspheres can then be washed, sintered, and mixed with tungsten powder for spark plasma sintering into the final fuel form

It will be appreciated by persons skilled in the art that numerous variations and/or modifications may be made to the invention as shown in the specific embodiments without departing from the spirit or scope of the invention as broadly described. Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It should be understood, therefore, that the invention might be practiced otherwise than as specifically set forth herein. The present embodiments are, therefore, to be considered in all respects as illustrative and not restrictive.

What is claimed is:

1. An apparatus for producing isotopes, comprising:
hollow tubing configured to be arranged around a nuclear reactor core and further configured to contain a circulating capsule-bearing fluid, said capsules containing a solution of a material to be irradiated;
a pump configured to force said circulating capsule-bearing fluid through said hollow tubing;
a capsule loading station configured to introduce a solution of starting material into capsules;
a capsule introduction station configured to introduce the capsules into said capsule-bearing fluid;
a capsule withdrawal station configured to withdraw irradiated capsules from said circulating fluid and remove irradiated sample from said capsules;
a separation station configured to receive said irradiated sample and separate a desired isotope from incomplete products and undesired products.

2. A method for producing isotopes, comprising:
encapsulating starting material-containing solution in capsules;
introducing said capsules into hollow tubing containing a circulating fluid, said hollow tubing configured to pass through a water shield of a nuclear reactor in proximity to a core of said nuclear reactor allowing said starting material to absorb neutrons generated from said nuclear reactor core as it moves through said hollow tubing with said circulating fluid;
pumping said circulating fluid through said hollow tubing;
removing capsules containing irradiated solution from said hollow tubing, and removing irradiated solution from said capsules;
chemically separating desired products from waste products and from products to be reintroduced to the circulating fluid for further exposure.

3. An apparatus according to claim 1 further comprising a nuclear reactor.

4. An apparatus according to claim 1 further comprising a TRIGA nuclear reactor.

5. An apparatus according to claim 1, wherein said hollow tubing is configured to form a coil around said nuclear reactor coil.

6. An apparatus according to claim 1, wherein said capsule withdrawal station includes an air lock chamber for extraction of the capsule from the circulating fluid.

7. A method according to claim 1, wherein said circulating fluid is water.

8. A method according to claim 2, wherein said circulating fluid is water.

9. A method according to claim 2, wherein said starting material-containing solution comprises NP-237 dissolved in aqueous nitric acid solution.

10. A method according to claim 2, wherein said circulating fluid is circulated at a rate that slows each capsule to spend from 2 to 40 days in the reactor.

11. A method according to claim 2 wherein irradiated solution is maintained outside of the core for three to 20 days prior to chemical separation.

12. A method according to claim 2, wherein said chemical separating comprises the use of ion exchange resin columns.

13. A method according to claim 9, wherein said desired product is PU-238.

14. A method according to claim 2 wherein said nuclear reactor is a TRIGA nuclear reactor.

15. A method for separating a desired isotope, resulting from the irradiation of a starting material in a nuclear reactor, from a starting material, comprising:
providing irradiated solution containing the desired isotope and the starting material to an ion exchange resin conditioned to adsorb the desired isotope and starting material, separating them from a carrier solution;
treating said ion exchange resin including adsorbed desired isotope and starting material with an eluting reagent selected to elute the desired isotope leaving the starting material adsorbed to said ion exchange resin;
treating said ion exchange resin including adsorbed starting material with an eluting reagent selected to elute the adsorbed starting material;

16. A method according to claim 15, further comprising returning a solution containing said eluted starting material to said reactor to produce additional desired isotope.

17. A method according to claim 15, further comprising treating a solution containing said eluted starting material to a reverse osmosis step to remove water and concentrate said solution containing said eluted starting material.

18. A method according to claim 17, further comprising using said removed water produced from said reverse osmosis step to prepare said eluting reagent selected to elute the adsorbed starting material.

19. A method according to claim 17, wherein said concentrated solution containing eluted starting material is returned to said nuclear reactor to produce additional desired isotope.
